(19) United States
(12) Patent Application Publication
(10) Pub. No.: US 2021/0239512 A1
(43) Pub. Date: Aug. 5, 2021

(54) METHOD FOR HANDLING AND CHECKING PRODUCTS IN GENERAL OR RAW MATERIAL IN BLOCKS OR SLABS

(71) Applicant: ANTOLINI BILANCE S.R.L., Massa (IT)

(72) Inventor: Mario ANTOLINI, Massa (IT)

(21) Appl. No.: 16/972,598

(22) PCT Filed: Jun. 5, 2019
(86) PCT No.: PCT/IB2019/054661

§ 371 Date: Dec. 6, 2020

(30) Foreign Application Priority Data
Jun. 7, 2018 (IT) 102018000006114

(51) Int. Cl. G01G 19/14; G01G 19/52

(52) U.S. Cl. CPC G01G 19/14; G01G 19/52

(57) ABSTRACT

A method for handling and checking heavy and/or bulky products in general or raw material in blocks or slabs, comprising the steps of:—pick up and moving said product or block/slab for loading said product/slab into a checking station;—carrying out the rotating of said product or block/slab around a horizontal axis in correspondence with said checking station;—simultaneously with said rotation of said product or block/slab carrying out the weighing of said product or block/slab in correspondence with said checking station; and—pick up and moving said product or block/slab for unloading said weighed product/slab out of said checking station.

The present invention relates to a method for handling and controlling products in general or raw materials in blocks or slabs.

The invention in question is advantageously used in various sectors of the manufacturing industry, to which the following description will make explicit reference without thereby losing generality, in particular both in the primary industrial sector, such as in the mining field for treatment and/or the processing of blocks of stone material or equivalent material being heavy and/or with large dimensions, than in the secondary industrial sector, such as in the metallurgical and steel industry during the production of metal coils, in the metalworking field, in the paper field or, again , in the field of the production of molds and printed materials or the like, being heavy and/or having large dimensions.

The object of the present invention is to provide a method for handling and controlling products or raw materials in blocks or slabs that is effective, reliable and quick to execute, also in view of the considerable very high weight and large dimensions that such products/blocks/slabs possess.

Another object is to provide a method for handling and controlling products or raw materials in blocks or slabs which guarantees the personnel involved total and constant safety.

A further object of the present invention is to provide a handling and control method which is economically advantageous, significantly reducing industrial costs. The structural and functional characteristics of the invention in question and its advantages with respect to the prior art will become even clearer from the underlying claims, and in particular from an examination of the following description relating to a preferred but not limiting embodiment of an apparatus implementing the methodology in object.

An apparatus for handling and controlling heavy and/or bulky products in general or raw materials in blocks or in slab and the like comprises, essentially as a whole, a control station defined by movement means, for example of the bridge crane or crane type to lift and load the products/blocks on board the apparatus and to lift again and unload the products/blocks from the apparatus at a control station, manipulator/tipper means for example of the type with pistons hydraulic actuators or equivalent systems to perform the rotation about a horizontal axis of the aforementioned products/blocks with a rotation angle of at least 90°, and of the control means suitable for weighing the cited products/blocks, for example of the type with load cells or equivalent systems which preferably they are mounted directly connected to said manipulating means.

The methodology in question performed by the aforementioned apparatus therefore includes the following operational phases:
picking up and moving a product or block/slab of raw material to be treated to load it and take it on board the equipment in said control station;
rotation of the product/block around the horizontal axis in said control station;
product/block control weighing, preferably but not limited to such weighing taking place simultaneously with the aforementioned product/block rotation; and
collection and handling of the product or block/slab of raw materials checked to discharge the product/block itself outside said control station.

The methodology in object for the handling and checking of products or raw materials in blocks or slabs heavy and/or having large dimensions, advantageously implemented using a single device, is therefore not only effective, safe, reliable and rapid execution, and also allowing an optimal visual quality control of said products/slabs, but moreover economically advantageous, significantly reducing industrial costs.

1. Method for handling and checking heavy and/or bulky products in general or raw material in blocks or slabs, comprising the steps of:
pick up and moving said product or block/slab for loading said product/slab into a checking station for controlling said product or block/slab;
carrying out the rotating of said product or block/slab around a horizontal axis in said checking station;
simultaneously with said rotation of said product or block/slab, carrying out the weighing of said product or block/slab in said checking station; and—pick up and moving said product or block/slab for unloading said weighed product/slab out of said checking station.

2. Method according to claim 1, characterized in that said weighing step occurs simultaneously with said rotation of said product or block/slab.

3. Method according to claim 1, characterized in that said rotation step comprises a tilting of said product or block/slab about said axis with a rotation angle of at least 90°.
